(19) United States
(12) Patent Application Publication
(10) Pub. No.: US 2018/0375356 A1
(43) Pub. Date: Dec. 27, 2018

(54) PORTABLE BATTERY CHARGER WITH SAFETY FEATURES FOR USE IN AN AUTOMOBILE

(71) Applicant: Halo2Cloud, LLC, Hartford, CT (US)

(72) Inventors: Garold C. Miller, Hartford, CT (US); Nathan Daniel Weinstein, Hartford, CT (US)

(21) Appl. No.: 15/726,698

(22) Filed: Oct. 6, 2017

Related U.S. Application Data
(63) Continuation of application No. 29/608,382, filed on Jun. 21, 2017.

(51) Int. Cl. H02J 7/00; H01R 13/66; H01R 13/717; H01R 25/00; B26B 11/00; B60R 22/32; A62B 3/00

(52) U.S. Cl. CPC H02J 7/0054; H02J 7/0047; H02J 7/0042; H01R 13/665; H01R 13/7175; B60R 2022/328; B26B 11/008; B60R 22/32; A62B 3/00; H02J 2007/005; H01R 25/00

(57) ABSTRACT

A portable battery charger comprises a generally Y-shaped charger housing having a first end and a second end, with a power connection input interface on the first end for connection to a power source and power connection interfaces on the split portions of the second end of the housing that can act as either a power input, a power output, or both. A rechargeable battery internally disposed within the charger housing is operably connected with the power connection input interfaces, the power connection output interfaces, and a power indicator means for indicating the power capacity in the internal battery unit. The charger includes additional emergency features, such as a light operable as a flashlight, a sharp edge or razor blade for cutting items as needed, and a sharp tip capable of break glass as needed. Further, the charger housing may include hardened portions capable of being used as a hammer.

### CROSS-REFERENCE TO RELATED APPLICATION

This application is a continuation of, and claims the benefit of, U.S. Design Application No. 29/608,382, filed Jun. 21, 2017, which is incorporated herein by reference in its entirety.

### FIELD OF INVENTION

The present invention generally relates to chargers for electronic devices, and more particularly relates to a portable battery charger with which a user can charge an electronic device directly from a standard power source, such as a car charger socket, or on-the-go from a portable and rechargeable power source.

### BACKGROUND OF THE INVENTION

Present day consumers typically own several electronic devices specifically designed for portability and on-the-go use, including, for example, a laptop computer, a mobile phone or smart phone, a portable music player like an iPod® or an MP3 player, a tablet like an iPad®, a portable gaming unit, a digital camera or camcorder, and the like. Each of these devices requires frequent recharging. Such electronic devices typically utilize a power cord or cable for connecting the device to a power source, such as a wall outlet, a car charger, an airplane charger, or a computer. However, a separate cable is usually required for each power source, and moreover, with some power sources, only one device can be plugged in at one time. Moreover, during recharging, the device must remain attached to the power source via the cable, which makes on-the-go use of the device difficult, as the user is tethered to one spot. When the device is disconnected from the power source or the cable, charging stops. This can be inconvenient if the device has not been sufficiently recharged for intended use away from a power source.

For example, when a phone is plugged into a car charger socket (e.g., a cigarette lighter socket) for recharging, the phone usually can still be used to make and receive calls. However, if the user wants or needs to disconnect the phone from the car charger socket for any reason—e.g., to take a call outside the car, to check a text message, search for directions, or if the user has reached her destination—without feeling tethered to one spot, the phone will stop charging when it is disconnected from the power source. Additionally, once the car engine is turned off, the phone may stop charging. In either of these situations, the phone battery may not have been charged sufficiently such that a call may be lost or the phone cannot be used sufficiently for intended functions when it is separated from a power source.

Additionally, different electronic devices often utilize different connection ports and interfaces such that a single power cord or charging device is not compatible with multiple power sources or multiple electronic devices. Accordingly, a tech-savvy consumer, with several electronic devices, will usually have multiple power cords or charging devices to keep track of for charging all the devices. Even then, the consumer may not always be in a place where a standard power source is readily available, or even if so, may not have the appropriate power cord or adapter available to use with a particular power source or electronic device.

Multi-source adapters are also available on the market for making a power cord compatible with multiple power sources. For example, a power cord with a traditional plug interface for connecting an electronic device to a wall outlet for recharging could exchange the plug with a car charger interface, or an airplane charger interface, or a standard USB interface. However, for such adapter devices, each of the power interfaces is usually a separate piece, and therefore difficult to keep track of when not in use, or, if stored away, may not be readily available when needed.

Additionally, most charging devices designed for use in a car are strictly limited to use as a charging device. Ideally, a charger would have additional functionality, especially when it is not needed as a charger and thus, not necessarily plugged into a car charger socket but readily available for other functions.

In view of the foregoing, there is a need for a portable battery charger that can be used to charge a variety of electronic devices, including but not limited to laptop computers, smart phones, mobile phones, data tablets, music players, cameras, camcorders, gaming units, e-books, Bluetooth® headsets and earpieces, GPS devices, and the like. Additionally, there is a need for such a battery charger that is portable and easily used in various conditions and locations to charge electronic devices, including but not limited to in a house or office, a car, with a computer, or even on-the-go where no standard power source is readily available. Accordingly, it is a general object of the present invention to provide a portable battery charger that improves upon conventional power chargers currently on the market and that overcomes the problems and drawbacks associated with such prior art devices and accessories.

### SUMMARY OF THE INVENTION

In accordance with the present invention, a portable battery charger is provided for charging electronic devices. In general, the battery charger may comprise a charger housing having a rechargeable battery unit provided therein, and a power input interface and a power output interface each in operative communication with the battery unit. In preferred embodiments of the present invention, the charger housing can take the form of a generally Y-shaped or a generally T-shaped device, though other shapes and designs may be used. In a Y-shaped or T-shaped housing, one end of the housing, having a single branch, acts as a power input and include a car charger interface adapted for engagement with a car charging socket or cigarette lighter. The other end of the housing in such a design includes two branches each having one or more power connection interfaces, such as female USB ports or male USB interfaces, each of which can act as either a power input, a power output, or both.

In additional embodiments, the battery charger can be combined with an adapter unit on the power input end to interface with various power sources, including U.S. and foreign wall sockets of varying designs, a car charger socket, an airline charger socket, and a USB interface. Alternatively, the power input can comprise multiple input connectors, each capable of attachment to a different power source, thereby eliminating the need for separate adapter pieces.

The battery charger can similarly be combined with an adapter unit at the power output interfaces to interact with various charging interfaces used on electronic devices, including a USB interface, a micro-USB interface, a mini-USB interface, an Apple Lightning® interface, an AC/DC interface, and the like. Such an adapter unit can comprise interchangeable parts, each adaptable to a different type of connection interface, or alternatively, include several different connection interfaces on the same part—e.g., a squid connector with multiple connectors.

In preferred embodiments of the present invention, the power charger includes one or more USB or similar connection ports for connecting electronic devices to the portable battery charger for recharging or data exchange, or for connection with an external power source for recharging the internal battery unit of the charger, without departing from the principles and spirit of the present invention.

In a first aspect of the present invention, the portable battery charger comprises a charger housing having a first end and a second end, with a power connection input interface on the first end for connection to a power source and at least one power connection output interface on the second end for connection to electronic devices needing recharging. A rechargeable battery internally disposed within the charger housing is operably connected with the power input and power output connection interfaces.

In an embodiment of the present invention, the power connection input interface is adaptable for use with a standard car charger socket—e.g., a cigarette lighter socket—but the charger is still usable separate from such a car charger socket for on-the-go recharging of electronic devices directly from an internal rechargeable battery disposed within the charger housing.

In another embodiment of the present invention, the power connection input interface is adaptable for use with a USB port, for example, provided on a personal computer. Indeed, the present invention can include more than one power input connection means to improve upon the functionality and usability of the charger, especially in emergency situations. For example, a power connection input port can be provided on the charger housing for connection to an external power source, such as a computer USB port, via a charging cable inserted into the input port.

In embodiments of the present invention, the power connection output interfaces on the second end of the charger housing can comprise a female connection port adapted to connect to an electronic device by use of a standard charging cable. More than one such port can be provided so that the charger can be connected with multiple devices at the same time. In alternate embodiments, a male connection interface can also be provided on the second end of the charger housing and act as a power input, or a power output, or both, wherein such male interface can be further concealed when not in use by a cap.

In another aspect of the present invention, a portable battery charger may further comprise a processing unit contained within the charger housing, which can keep track of the capacity level of the rechargeable battery unit disposed therein, store data or provide a conduit means by which data can be exchanged between electronic devices, such as between a smart phone and a computer.

In another aspect of the present invention, a power indicator is provided on the charger housing to indicate the power level of the internal rechargeable battery unit. The power indicator can comprise a light or series of lights, a digital readout, or other known forms of indicating power level of a battery. Additional indicator means can be utilized in the present invention for various functionalities, including but not limited to indicating that a charge is being provided to an electronic device, either from a standard power source or the internal battery unit of the portable battery charger, or indicating the power level in an electronic device attached to the charger via the power connection output interface.

In various embodiments of the present invention, additional features can be provided to improve the functionality of the power charger, especially when it is not in use or needed to recharge electronic devices. For example, the charger housing may include a light operable as a flashlight, flare or safety beacon. A sharp edge or razor blade can be provided on the housing to assist the user in cutting items as needed, such as a seat belt following a car accident. Further, the tip of the housing, for example, on the end of the car charger interface, can be hardened, pointed and sharpened to help the user to break a car window, as needed. Similarly the opposite end can be hardened to act as a hammer or glass-breaker for emergency situations.

These and other objects, features and advantages of the present invention will become apparent in light of the detailed description of embodiments thereof, as illustrated in the accompanying drawings.

### BRIEF DESCRIPTION OF THE DRAWINGS

FIG. 1 shows a first perspective view of a portable battery charger in accordance with a first embodiment of the present invention.

FIG. 2 shows a top planar view of the portable battery charger of FIG. 1.

FIG. 3 shows a bottom planar view of the portable battery charger of FIG. 1.

FIG. 4 shows a left-hand planar view of the portable battery charger of FIG. 1.

FIG. 5 shows a right-hand planar view of the portable battery charger of FIG. 1.

FIG. 6 shows a back-end planar view of the portable battery charger of FIG. 1.

FIG. 7 shows a front-end planar view of the portable battery charger of FIG. 1.

### DETAILED DESCRIPTION OF THE DRAWINGS

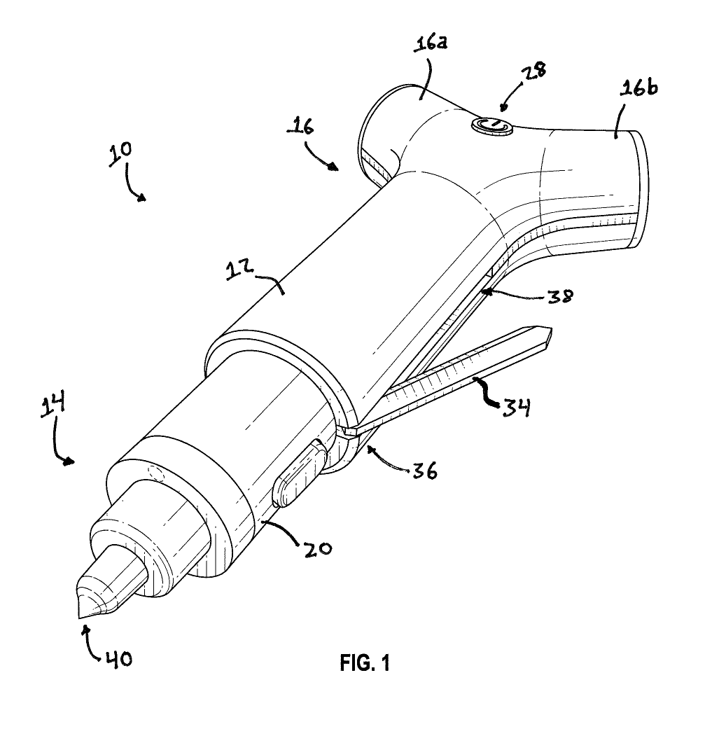

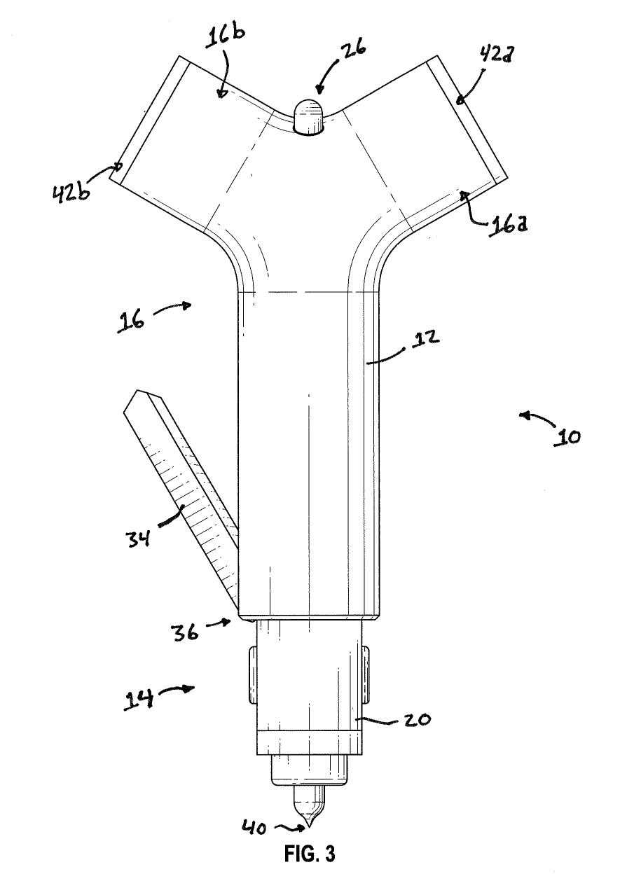

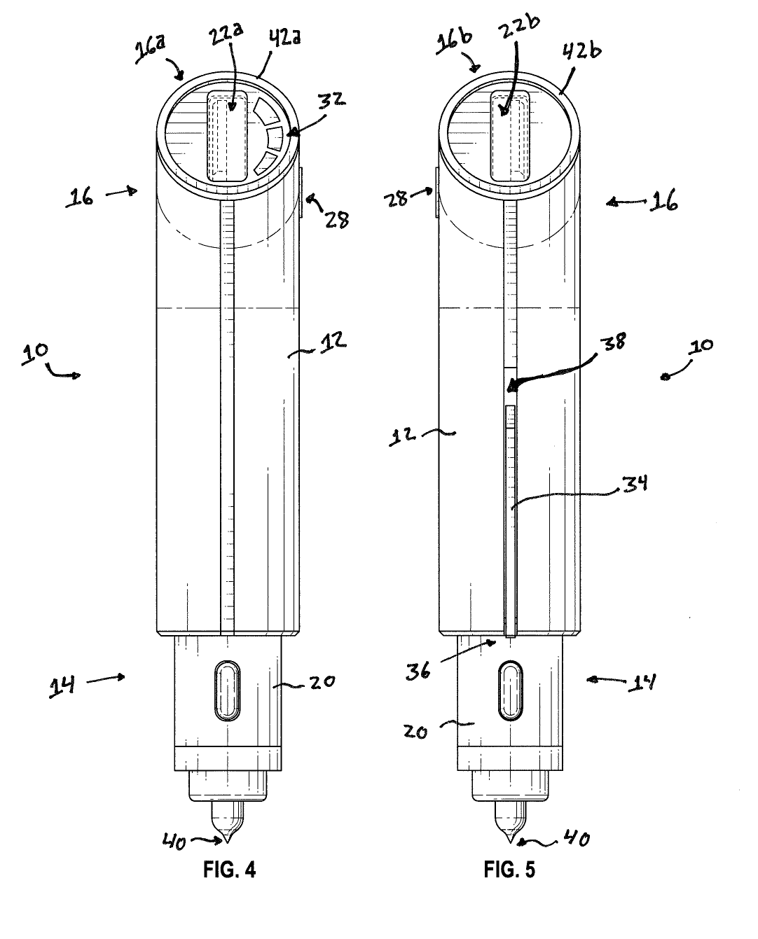

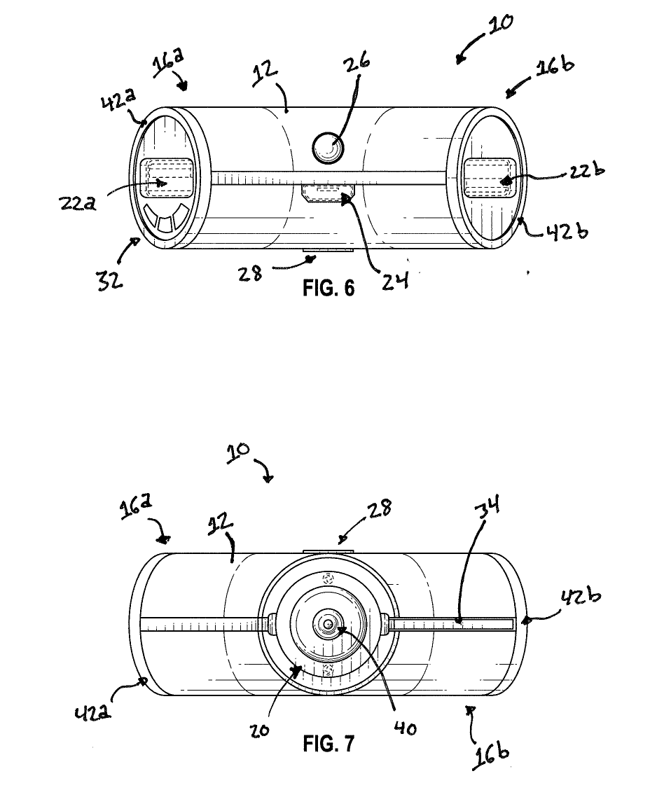

A portable battery charger in accordance with the present invention is shown in FIGS. 1-7, and generally designated therein as reference numeral 10. The charger 10, as illustrated, generally comprises a charger housing 12 having a rechargeable battery unit provided therein, and defines a first “input” end 14 and a second “output” end 16. In general, a power input interface is provided on the first end 14 of the housing 12, and at least one power output interface is provided on the second end 16 of the housing 12. As illustrated in the embodiment of FIG. 1, the first “input” end 14 of the charger housing 12 includes a car charger interface 20 adapted for engagement with a standard car charger socket, or cigarette lighter. The opposing “output” end 16, as illustrated, is split into two branches 16a and 16b, each with its own power connection interface, such as shown in more detail in FIGS. 4-6. As described further below, these power connection interfaces preferably acts as power outputs for charging electronic devices connected to the charger 10. However, each interface may be capable of acting as a power input, a power output, or both in accordance with the spirit and principles of the present invention.

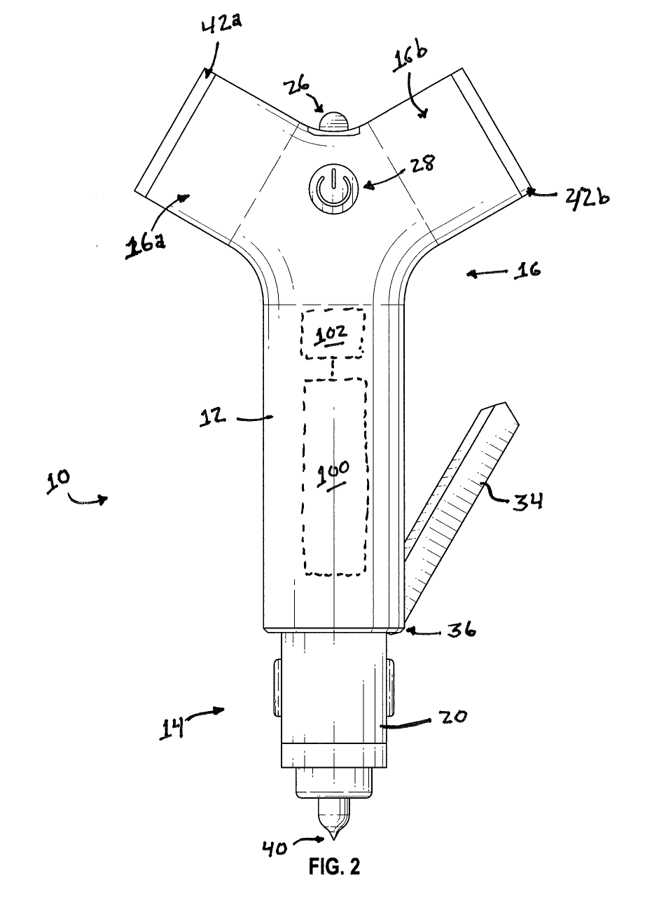

As shown in FIG. 2, the housing 12 is generally Y-shaped, with the first “input” end 14 having a single branch and the second “output” end having two branches. In use, the illustrated car charger interface 20 can be inserted into a car charger socket, while the output end 16 extends outwardly therefrom so that electronic devices can be connected to the charger 10 for recharging via the car charger socket or from the internal battery of the charger 10. Other shapes and designs may be used without departing form the spirit and principles of the present invention. For example, an alternate housing design can be generally T-shaped and resemble a hammer.

Referring to FIG. 6, the second end 16 of the housing 12 includes power connection USB ports 22a and 22b, and a power connection micro-USB port 24, each operatively connected with the internal battery of the charger 10. While the second, split end 16 of the charger housing 12 is generally illustrated and described herein as an “output” end, the power connection interfaces 22a, 22b and 24 on that end 16 may act as either a power input, a power output, or both in accordance with embodiments of the present invention. For example, the two USB ports 22a and 22b can be designated as power output ports whereby electronic devices can be connected to the charger 10 via standard charger cables (not shown) and recharged from the internal battery of the charger 10 or via an external power source when the charger 10 is connected to such a power source, such as a car charger socket when the car charger interface 20 is engaged therewith. The micro-USB port 24 can be designated as a power input where the internal battery of the charger 10 can be recharged when the charger 10 is connected with an external power source via the port 24, such as by using a standard charger cable to connect the charger 10 to a computer or a wall socket.

Moreover, though the interfaces on the second “output” end 16 are generally illustrated and described herein a female connection ports, male connection interfaces may be used on that end of the housing 12 as power inputs, power outputs, or both, without departing from the general spirit and principles of the present invention. For example, in an alternate embodiment, a male interface, such as a male USB interface, can be provided on one of the branches 16a or 16b of the Y-shaped housing 12, and covered by a hardened cap when not needed, whereby the cap can be used as a hammerhead for breaking a car window in an emergency situation.

In accordance with the present invention, the power charger 10 can also be combined with or incorporate an adapter unit on the power input end 14 to interface with various additional power sources, including U.S. and foreign wall sockets of varying designs, an airline charger socket, and a USB interface, such as the adapter unit described and illustrated in U.S. Pat. No. 9,093,848, issued Jul. 28, 2015, which shares common inventors with the present application and which is incorporated herein by reference.

The charger 10 can similarly be combined on the power output end 16 with an adapter unit adapted for the power output interfaces 22a, 22b and 24 to interface with various charging interfaces used on electronic devices, including for example a USB interface, a mini-USB interface, a micro-USB interface, an Apple Lightning® interface, an AC/DC interface, and the like. Such an output adapter unit can comprise interchangeable pieces, each adaptable to a different type of interface, or alternatively, the portable power charger 10 can include an output interface collectively comprising multiple different interfaces or be adapted for use with an adapter comprising multiple different interfaces on the same part—e.g., a squid connector with multiple connectors.

A rechargeable battery, generally designated in FIG. 2 by reference numeral 100, is internally disposed within the charger housing 12 and operatively connected with the power connection input interfaces 20 and 24 and the power connection output interfaces 22a and 22b. More particularly, the rechargeable battery unit 100 is operatively connected with the power connection input interface(s) for recharging the battery 100 when the charger 10 is connected to an external power source. The rechargeable battery 100 is also operatively connected with the power connection output interface(s) for recharging electronic devices connected to the charger 10 from the rechargeable battery unit 100. In preferred embodiments, the battery unit 100 comprises a Lithium-Ion battery.

As illustrated, the power connection input interface 20 is adapted for connection to a standard car charger socket—e.g., a cigarette lighter socket. As noted, at least one of the power connection ports on the power output end 16 of the charger housing 12, such as micro-USB port 24, can be provided to recharge the internal battery unit 100 via a charging cable connected to an external power source, such as a computer, so that the charger 10 can be recharged even when it is not in a car and thus not near a car charging socket. In an alternate embodiment, such a power input connection port could be provided on the same “input” end 14 of the charger housing 12 near the car charger interface 20. Still further, the present invention can utilize a design that permits interchanging of power input connector adapter pieces for use with a variety of standard power sources, including by simply changing out the power connection input interface 20 or modularly adapting the power input end 14 of the charger housing 12 to adapt to whatever power source is available at a particular time. For example, the power input end 14 of the charger housing 10 could be provided with a single, multi-functional power input adapter or a fixed power connection input interface that includes interfaces for two or more power sources, such as the design shown in U.S. Pat. No. 9,093,848, wherein the power input end 14 of the charger 10 comprises an interface that permits connection to a standard U.S. wall socket, a car charger socket, an airline charger socket, and a computer, as necessary.

As illustrated in FIG. 6, the power connection output interfaces on the output end 16 of the charger housing 12 comprise female power connection ports, and more particularly, standard female USB ports, commonly used with many charging cables for electronic devices on the market. As noted, the power output interfaces can comprise various interface connector designs, or utilize interchangeable connector adapter pieces, including micro-USB, mini-USB, Apple Lightning®, AC/DC, and the like, without departing from the spirit and principles of the present invention.

The charger housing 12 also encloses various electrical components (such as integrated circuit chips and other circuitry) to provide computing operations for the device—e.g., by converting the DC input from the car charger interface 20 to an AC output suitable for common electronic devices such as a smart phone or a tablet using an inverter within the charger housing 12. The integrated circuitry and other components may comprise a power supply (e.g., the internal rechargeable battery), a microprocessor and controller (e.g., a CPU), memory (e.g., ROM, RAM, flash), a circuit board, a hard drive, and/or various input/output (I/O) support circuitry. The electrical components may also include components for sending and receiving data and media (e.g., antenna, receiver, transmitter, transceiver, Bluetooth, etc.).

In general, the charger 10 comprises a controller, generally represented in FIG. 2 as reference numeral 102, including a processing unit, configured to execute instructions and to carry out operations associated with the charger 10. For example, the processing unit can keep track of the capacity level of the battery unit 100, store data or provide a conduit means by which data can be exchanged between electronic devices, such as between a smart phone and a computer. The processing unit communicates with the battery unit 100 to determine how much capacity is remaining in the battery. Upon determining the capacity level, the processing unit can communicate with a power indicator means 32 provided on the exterior of the charger housing 12 to provide the user with information for how much capacity is remaining in the internal rechargeable battery unit 100. Exemplary power indicator means 32 for the illustrated embodiment is shown in FIGS. 4 and 6 and described in more detail below.

The processing unit also includes a smart interface to determine the total current required for specific devices connected to the charger 10. In this regard, the processing unit operates in connection with input/output (I/O) support circuitry to control interactions with devices connected to the charger 10. The I/O support circuitry may be integrated with the processing unit or may be a separate component. Generally, the I/O support circuitry operates by exchanging power (and possibly data) between the charger 10 and electronic devices connected thereto via the power connection output interfaces 22a and 22b.

The processing unit may further include a storage unit that provides a place to hold data or instructions for operation of the charger 10 and rechargeable battery unit 100, or data exchanged between the charger 10, a computer, and electronic devices connected to the charger 10, or memory needed for further operations of the charger 10, including but not limited to recharging of the internal battery unit 100.

The charger 10 is readily portable and easily storable when not in use as a result of the small size and shape, as generally illustrated in FIG. 1. Despite the small size of the charger housing 12, in accordance with the embodiments described and shown herein, the power capacity is very high so that the rechargeable internal battery unit 100 can accommodate multiple electronic devices at the same time, if necessary. Moreover, with the portability of the charger 10, it can be used on-the-go even when not connected to an external power source, such as a car charger socket, whereby electronic devices can be recharged directly from the internal rechargeable battery unit 100 via the power output interfaces 22a and 22b.

In accordance with intended operation of the portable charger 10, a user can recharge one or more electronic devices using the internal rechargeable battery unit 100, a car charger socket, or a computer. For example, the portable charger 10 of the present invention can be used to charge smart phones, mobile phones, data tablets, laptop computers, music players, cameras, camcorders, gaming units, e-books, Bluetooth® headsets and earpieces, GPS devices, and the like. In operation, the rechargeable battery unit 100 can be recharged by connecting the charger 10 to an external power source, such as a car battery or a computer, using the power connection input interface 20 or the input connection port 24, respectively. Indeed, the car charger interface 20 can be inserted into a car charger socket, leaving the connection interfaces 22a and 22b on the second “output” end 16 of the charger housing 12 available for connection to electronic devices where both are capable of acting as a power output. In embodiments where a connection port on the “output” end 16 is capable of acting as a power input, such as illustrated connection port 24, that port 24 can alternatively be connected to an external power source using a standard charging cable while the other connection ports 22a and 22b (and any other “output” interface provided on the charger 10) is connected to electronic devices to output power provided from the external power source.

In operation, any time the charger 10 is connected to an external power source, an electronic device can be connected to the charger 10 via a power connection output interfaces 22a and 22b. When the charger 10 is connected to an external power source, the electronic device will be recharged directly from the external power source. This can be done at the same time as when the rechargeable battery unit 100 inside the charger 10 is being recharged. When the charger 10 is disconnected from the external power source, the rechargeable battery unit 100 can be used to recharge any electronic device connected to the charger 10 via a power output interfaces 22a and 22b, which is especially useful for on-the-go use of an electronic device, or when the user needs to recharge an electronic device where no external power source is readily accessible.

Referring to FIGS. 4 and 6, the portable charger 10 also includes a power indicator means 32 that will indicate not only that an electrical current is being supplied to an electronic device connected to the power connection output interfaces 22a and 22b, but also the remaining capacity of the internal rechargeable battery unit 100 in the charger 10. For example, in an embodiment of the present invention, the power indicator means 32 comprises a series of three lights, but can include more or fewer lights without departing from the principles and spirit of the present invention. In operation, when the battery 100 is at full capacity, all the lights will be lit up. As the battery power decreases, the lights will correspondingly decrease one by one as the power is used. If there is no capacity left in the internal battery 100, none of the lights will be lit up, or the lights may turn red, indicating insufficient power level for charging. Additionally or alternatively, the power indicator means 32 can include informative descriptors—e.g., “F” designating “full” capacity, “½” designating “half” capacity, and “E” designating “empty”—or can change color—e.g., green designating “full” capacity, yellow designating “half” capacity, and red designating “empty”—or can comprise a digital interface that provides a battery capacity level for the internal rechargeable battery unit, or another known means of providing battery level information.

The processing unit of the charger 10, which can keep track of the capacity level of the internal rechargeable battery unit 100, store data or provide a conduit means by which data can be exchanged between electronic devices, such as between a smart phone and a computer, communicates with the battery unit 100 to determine how much capacity is remaining in the battery 100. Upon determining the capacity level, the processing unit communicates with the power indicator means 32 to provide the user with the appropriate signal for showing how much capacity is remaining in the internal battery 100.

The processing unit may also includes a smart interface to determine the total current required for the specific electronic devices connected to the battery charger 10. Additionally, the battery charger 10 may comprise an internal switch (not shown) to draw power from the rechargeable battery unit 100 or essentially turn off the battery unit 100. For example, the processing unit can determine if the charger 10 is connected to an external power source. If so, when an electronic device is also connected to the charger 10, the processing unit can ensure that the electronic device is being charged directly from the external power source instead of drawing power from the rechargeable battery unit 100 as it is being recharged itself. Further, the processing unit can determine when the charger 10 is disconnected from an external power source, and, if still connected to an electronic device, sufficiently switch the internal circuitry of the battery charger 10 so that the electronic device continues to be recharged from the rechargeable battery unit 100 without delay.

The processing unit also preferably includes a timer for automatically turning the battery charger off if there is no device attached to the charger 10 for a predetermined period of time, or if any device still attached to the charger 10 has reached maximum capacity. In this regard, the capacity of the internal rechargeable battery unit 100 in the charger 10 can be preserved. Upon shut down of the charger 10, the power indicator means 32 will indicate that the charger 10 is being turned off—for example, the lights will provide a sequential blinking signal.

Additional indicator means can be utilized in the present invention for various functionalities, including but not limited to indicating that a charge is being provided to an electronic device, either from a standard external power source or from the internal rechargeable battery unit 100 of the portable charger 10, or indicating the power level in an electronic device attached to the power charger 10 via the power connection output interfaces 22a and 22b.

Referring to FIGS. 1-2, other features are provided on the charger housing to increase the functionality of the charger 10, especially in a car and preferably in situations where the car charger 10 is not in use or otherwise needed. For example, emergency features can be provided to make the charger 10 an essential safety device for the car.

Referring to the FIG. 2, an LED light 26 is provided on the second “output” end 16 of the charger housing 12. This LED light 26—preferably in operative communication with the internal battery unit 100, can act as a flashlight, or a roadside flare, or an emergency beacon, to help the user in emergency situations, such as when the car breaks down. A manual power button 28 can be provided on the charger housing for turning the LED light 26 on and off, as needed.

Still referring to FIG. 2, a sharp edge or razor blade 34 can be provided on a side of the charger housing 12, either fixed in place projecting at a slight angle from the housing 12, or pivotable between an extended condition whereby the sharp edge or blade 34 is exposed for use and a retracted position whereby the sharp edge or blade 34 is safely stored within the charger housing 12 when not in use. In intended operation of either embodiment, the sharp edge or blade 34 is available to a user to cut a seatbelt in an emergency situation, such as a car accident where the user needs to expeditiously release herself from the seat belt. The sharp edge or blade 34 can also be used to cut other items, as needed.

In embodiments where the sharp edge or blade 34 is pivotably movable between an extended condition (shown in FIG. 2) and a retracted condition (not shown), an end of the sharp edge or blade 34 is pivotably connected to the charger housing 12 at a pivot point 36, such as illustrated in the figures. As so connected, the sharp edge or blade 34 can be moved as desired between the extended condition and the retracted condition. To store or maintain the sharp edge or blade 34 in the retracted condition, a cavity 38 is provided in the charger housing 12.

Referring to FIG. 1, the tip 40 of the car charger interface 20 can also be hardened, pointed, and sharpened to act as a glass-break pin in emergency situations when the user needs to break a car window. Alternatively, the housing 12 can be constructed from a hardened material so that the second “output” end 16 of the charger housing 12, especially when using a Y-shaped or T-shaped housing as discussed above, can act as a hammer for breaking a car window as needed. For example, one or both of the branches 16a and 16b can be hardened to be capable of breaking glass without affecting operation of the charger components. Referring to FIGS. 4-5, a rim 42a and 42b on each branch 16 and 16b, can be outwardly offset from the connection ports 22a and 22b and be hardened for use as a hammer in an emergency situation. Alternatively, the charger housing 12 can include caps that slide over the branches 16a and 16b to protect the ports 22a and 22b when not in use, and such caps can reinforce the charger housing 12 for use as a tool.

The foregoing description of embodiments of the present invention has been presented for the purpose of illustration and description. It is not intended to be exhaustive or to limit the invention to the form disclosed. Obvious modifications and variations are possible in light of the above disclosure. The embodiments described were chosen to best illustrate the principles of the invention and practical applications thereof to enable one of ordinary skill in the art to utilize the invention in various embodiments and with various modifications as suited to the particular use contemplated.

What is claimed is:

1. A portable battery charger for recharging at least one electronic device having a rechargeable internal battery, said charger comprising:
a charger housing defining a first end and a second end; and
a rechargeable battery internally disposed within the charger housing;
wherein the first end of the charger housing includes a power connection input interface operatively connected with the rechargeable battery for providing a charge to the rechargeable battery when the charger is connected to an external power source via the power input interface; and
wherein the second end is split into two portions each having a respective power connection interface operatively connected with the rechargeable battery, at least one of the power connection interfaces on said second end comprising a power output for providing a charge from the charger to an electronic device connected to the charger via said power connection output interface.

2. The portable battery charger according to claim 1, wherein the power connection input interface comprises a car charger interface adapted for use with a car charger socket.

3. The portable battery charger according to claim 1, wherein the charger housing is generally Y-shaped.

4. The portable battery charger according to claim 1, wherein the second end further includes a power connection input port for providing a charge to the rechargeable battery when the charger is connected to an external power source via the power connection input port.

5. The portable battery charger according to claim 1, wherein at least one of said second end portions is made from a hardened material giving said portion the capability of being used as a hammer.

6. The portable battery charger according to claim 1, further comprising an LED light feature.

7. The portable battery charger according to claim 1, further comprising a longitudinal blade member extending from the charger housing.

8. The portable battery charger according to claim 7, wherein said blade member includes a pointed end projecting outwardly from the charger housing at an acute angle thereto, and further having a sharpened edge on a side of the blade member facing towards the housing.

9. The portable battery charger according to claim 8, said blade member being attached to the charger housing at a pivot point such that the blade member is movable between an extended condition where the sharpened edge is exposed, and a retracted condition where the sharpened edge is hidden.

10. The portable battery charger according to claim 9, wherein a cavity is defined in the charger housing and adapted for receiving the blade member in its retracted condition.

11. The portable battery charger according to claim 1, wherein the first end of the charger housing comprises a sharp tip capable of breaking glass.

12. The portable battery charger according to claim 1, further comprising power indicator means operatively connected with the rechargeable battery for indicating at least one of the power capacity of the rechargeable battery of the charger and the power capacity of an electronic device connected to the charger via said power connection output interface.

13. A portable battery charger for recharging at least one electronic device having a rechargeable internal battery, said charger comprising:
a generally Y-shaped charger housing defining a first end and a second end;
a rechargeable battery internally disposed within the charger housing;
an LED light feature provided on the surface of the charger housing and being operatively connected with the rechargeable battery; and
a longitudinal blade member extending from the charger housing;
wherein the first end of the charger housing includes a power input interface comprising a car charger interface adapted for use with a car charger socket, said power input interface being operatively connected with the rechargeable battery for providing a charge to the rechargeable battery when the charger is connected to a car charger socket via the power input interface; and
wherein the second end is split into two portions each having a respective power connection interface operatively connected with the rechargeable battery, at least one of the power connection interfaces on said second end comprising a power output for providing a charge from the charger to an electronic device connected to the charger via said power connection output interface.

14. The portable battery charger according to claim 13, wherein the second end further includes a power connection input port for providing a charge to the rechargeable battery when the charger is connected to an external power source via the power connection input port.

15. The portable battery charger according to claim 13, wherein at least one of said second end portions is made from a hardened material giving said portion the capability of being used as a hammer.

16. The portable battery charger according to claim 13, wherein said blade member includes a pointed end projecting outwardly from the charger housing at an acute angle thereto, and further having a sharpened edge on a side of the blade member facing towards the housing.

17. The portable battery charger according to claim 16, said blade member being attached to the charger housing at a pivot point such that the blade member is movable between an extended condition where the sharpened edge is exposed, and a retracted condition where the sharpened edge is hidden.

18. The portable battery charger according to claim 17, wherein a cavity is defined in the charger housing and adapted for receiving the blade member in its retracted condition.

19. The portable battery charger according to claim 13, wherein the first end of the charger housing comprises a sharp tip capable of breaking glass.

20. The portable battery charger according to claim 13, further comprising power indicator means operatively connected with the rechargeable battery for indicating at least one of the power capacity of the rechargeable battery of the charger and the power capacity of an electronic device connected to the charger via said power connection output interface.
